(19) United States
(12) Patent Application Publication
(10) Pub. No.: US 2011/0149559 A1
(43) Pub. Date: Jun. 23, 2011

(54) LOCATION DEVICE

(76) Inventor: James David Fuqua, JR., Harrisonburg, LA (US)

(21) Appl. No.: 12/878,022

(22) Filed: Sep. 8, 2010

Related U.S. Application Data
(60) Provisional application No. 61/240,365, filed on Sep. 8, 2009.

(51) Int. Cl. F21L 4/08

(52) U.S. Cl. 362/183

(57) ABSTRACT

A location device for use in various electronic devices. The location device can have a GPS receiver and a GPS antenna, as well as a communication element for transmitting the GPS data. The location device is configured to be used with other common electronic devices for tracking of status and location of individuals.

### CONTINUITY DATA

This application claims priority to and the benefit of U.S. Provisional Application No. 61/240,365 filed on Sep. 8, 2009, entitled “Location Module.”

### FIELD OF THE INVENTION

The present invention relates generally to GPS device with transmission capabilities, and most particularly to a location based wireless system for use in various electronic devices.

### BACKGROUND OF THE INVENTION

The Global Positioning System (GPS) is a U.S. space-based global navigation satellite system. It provides reliable positioning, navigation, and timing services to worldwide users on a continuous basis. GPS comprises satellites orbiting the Earth, control and monitoring stations on Earth, and the GPS receivers owned by users. GPS satellites broadcast signals from space that are used by GPS receivers to provide three-dimensional location.

Since it became fully operational in 1995, GPS has become a widely used aid to navigation worldwide. It has become a mainstay of transportation systems worldwide, providing navigation for aviation, ground, and maritime operations. Disaster relief and emergency services depend upon GPS for location and timing capabilities in their life-saving missions. Everyday activities such as banking, mobile phone operations, and even the control of power grids, are facilitated by the accurate timing provided by GPS. Farmers, surveyors, geologists and countless others perform their work more efficiently, safely, economically, and accurately using the free and open GPS signals.

Our nation's law enforcement officers and other public servants use GPS in a variety of ways. For instance, most police and fire/rescue vehicles are equipped with GPS tracking modules to enable dispatchers to know the precise location of each vehicle. Additionally, some public servants carry cell phones that are personally trackable, although this option is not always desirable because the cell phone power source is continually drained by the cell phone itself and when it is off or drained, the GPS receiver does not function. Consequently, these technologies are also utilized for monitoring parolees and various types of home incarceration, work permitted individuals throughout the criminal justice system.

Accordingly, it remains desirable to address the limitations of the GPS and cell phone combination and provide public servants and other personnel with a product that is continually powered on and does not comprise the limitations associated with known methods and systems, including but not limited to those limitations discussed above.

### SUMMARY

Presented herein is a location device for use in various electronic devices. In one aspect, the location device comprises a GPS receiver and a GPS antenna. Additionally, in one aspect, the location device comprises a communication element for transmitting the GPS data to a remote receiver. The location device may also comprise a rechargeable power source that can charge simultaneously with the power source of the device within which it resides, or separately, if desired.

In yet another aspect, the location device can be part of a tracking system. The tracking system, in one aspect, comprises one or more location devices and a computer aided dispatch system. The computer aided dispatch and device mapping system can be configured to receive the GPS data from the one or more location devices, store the location data, and display the data, including time, location, speed, and the like, on a computer screen or other capable device. It can also have the capability to transmit the location data externally, such as over the internet.

Related methods of operation are also provided. Other apparatuses, methods, systems, features, and advantages of the location device will be or become apparent to one with skill in the art upon examination of the following figures and detailed description. It is intended that all such additional apparatuses, methods, systems, features, and advantages be included within this description, be within the scope of the location device, and be protected by the accompanying claims.

### DESCRIPTION OF THE FIGURES

The accompanying drawings, which are incorporated in and constitute a part of this specification, illustrate certain aspects of the instant invention and together with the description, serve to explain, without limitation, the principles of the invention.

FIG. 1 is an exemplified block diagram of one aspect of a location device for installation within a flashlight;

FIG. 2 is a schematic view of exemplified electronic circuits for the location device of FIG. 1, showing circuits for a power supply, a GSM antenna, a GPS antenna, a modem, a GPS receiver, and a SIM card;

FIG. 3 is a partially exploded perspective view of the location device of FIG. 1;

FIG. 4 is a perspective view of an exemplified location device, showing the end cap and a recharging port;

FIG. 5 is a cut away perspective view of the location device of FIG. 4, cut substantially along its longitudinal axis; and

FIG. 6 is a cut away perspective view of an end cap for use with the location device of FIG. 4.

### DESCRIPTION OF THE INVENTION

The present invention can be understood more readily by reference to the following detailed description, examples, and claims, and their previous and following description. Before the present system, devices, and/or methods are disclosed and described, it is to be understood that this invention is not limited to the specific systems, devices, and/or methods disclosed unless otherwise specified, as such can, of course, vary. It is also to be understood that the terminology used herein is for the purpose of describing particular aspects only and is not intended to be limiting.

The following description of the invention is provided as an enabling teaching of the invention in its best, currently known aspect. Those skilled in the relevant art will recognize that many changes can be made to the aspects described, while still obtaining the beneficial results of the present invention. It will also be apparent that some of the desired benefits of the present invention can be obtained by selecting some of the features of the present invention without utilizing other features. Accordingly, those who work in the art will recognize that many modifications and adaptations to the present invention are possible and can even be desirable in certain circumstances and are a part of the present invention. Thus, the following description is provided as illustrative of the principles of the present invention and not in limitation thereof.

As used herein, the singular forms “a,” “an” and “the” include plural referents unless the context clearly dictates otherwise. Thus, for example, reference to an “enclosure” includes aspects having two or more enclosures unless the context clearly indicates otherwise.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

As used herein, the terms “optional” or “optionally” mean that the subsequently described event or circumstance may or may not occur, and that the description includes instances where said event or circumstance occurs and instances where it does not.

In one aspect, presented herein is a location device 10 for use in various electronic devices. For example, and not meant to be limiting, the electronic device can be a flashlight. In this aspect, the device comprises a housing 100 defining an interior cavity 110. A light assembly 120 comprising a light source 125 positioned at least partially within a portion of the interior cavity 110 can be positioned substantially adjacent the distal end 102 of the housing 100. The device also comprises a location module 200 positioned at least partially within the interior cavity and configured to generate location data for the device. In one exemplified aspect, the location module 200 comprises a GPS receiver 210 and a GPS antenna 220. In another aspect, the location module also comprises an RF antenna 230. In still another aspect, the location module includes an accelerometer.

In another aspect, the device comprises a communication element 300 positioned at least partially therein the interior cavity of the tubular housing for transmitting the GPS data to a remote receiver (not shown). The communication element 300, for example, can comprise a quad band GSM modem, a CDMA modem, or a short range RF modem for use with WIFI and home based unlicensed 900 mhz spectrum, as well as Bluetooth. One example of a communication element comprises a GSM or CDMA based module that utilizes both GPS and AGPS location (Assisted GPS) services. In one exemplified aspect, the communication element can comprise a Qualcomm WMD module that uses both GSM and CDMA, as well as location module elements, such as GPS, AGPS, RF, and an accelerometer.

In another aspect, the location device 10 also comprises a Subscriber Identity Module, or SIM card 310. The SIM card 310 is coupled to the communication element. The SIM card can be, for example and not meant to be limiting, an Infineon™ SLM76 series chip. However, as one skilled in the art can appreciate, other SIM cards are contemplated for use with the communication element.

The communication element 300 can, for example, be coupled to the GPS receiver 210 via a universal asynchronous receiver/transmitter (UART). In this aspect, the GPS receiver can be coupled to the GPS antenna 220 using a miniature RF connector. For example, and not meant to be limiting, the RF connector may comprise a miniature BNC, UHF, or IPX connector. Additionally, the communication element can also be coupled to a GSM PIFA, or other antenna, using a miniature RF connector.

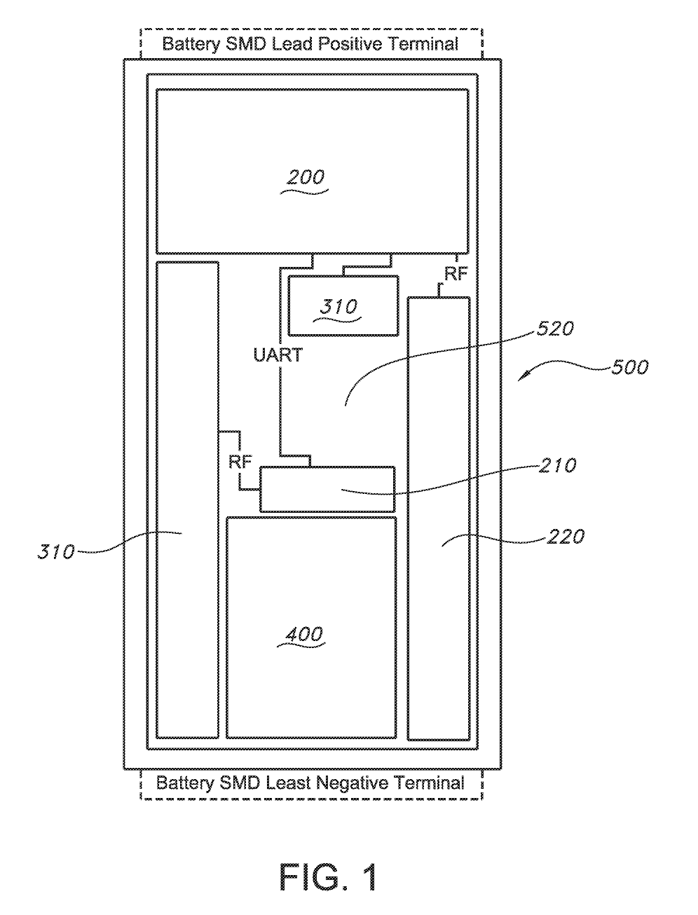

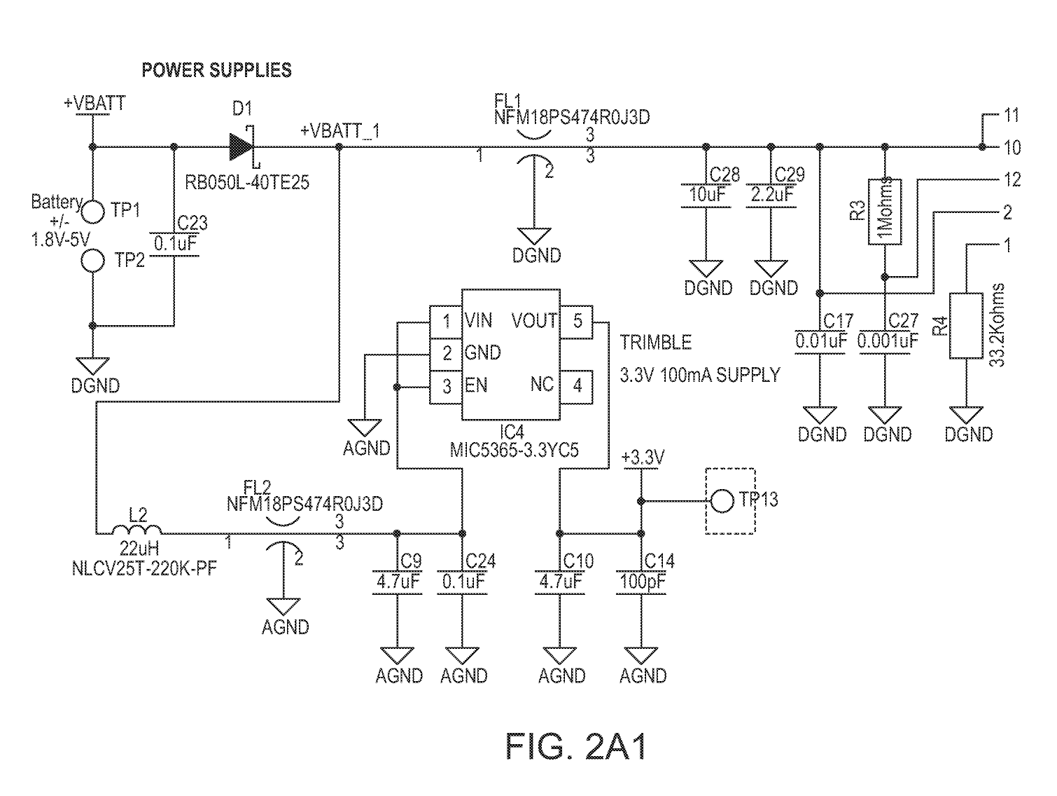

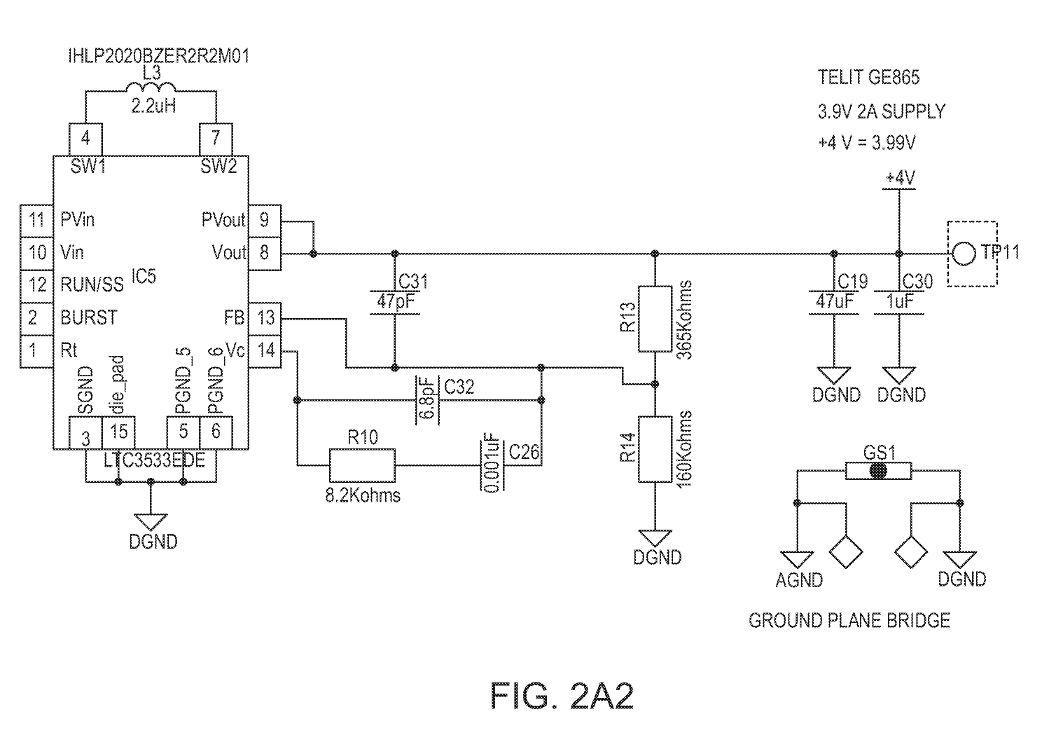

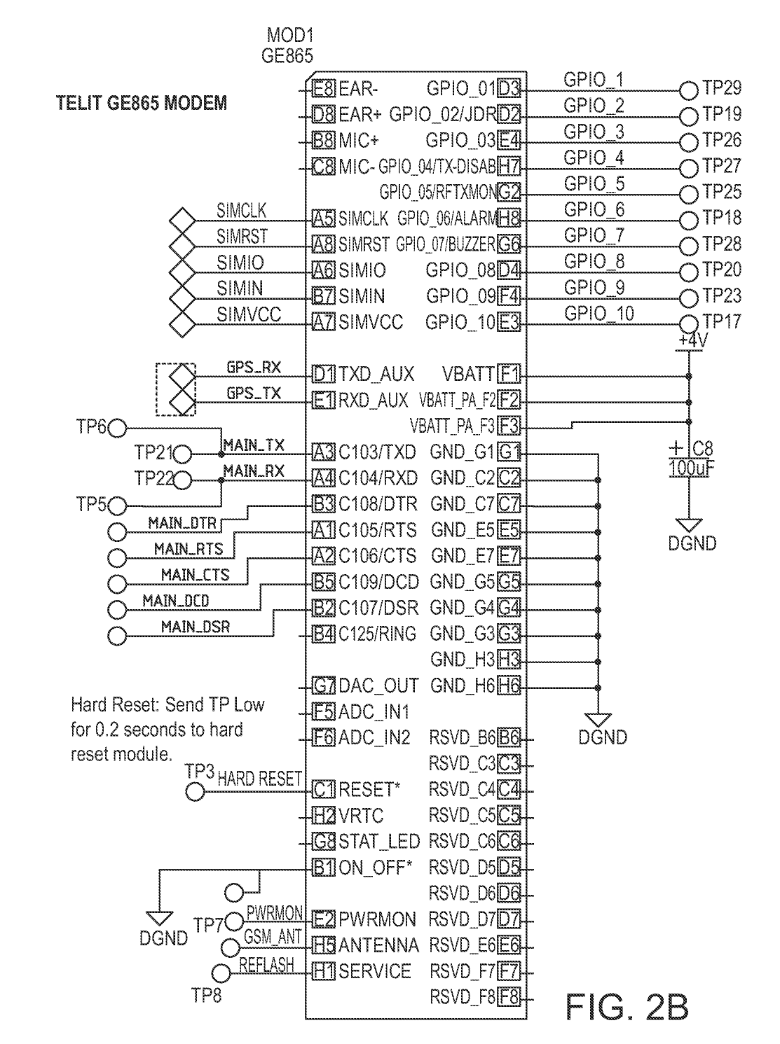

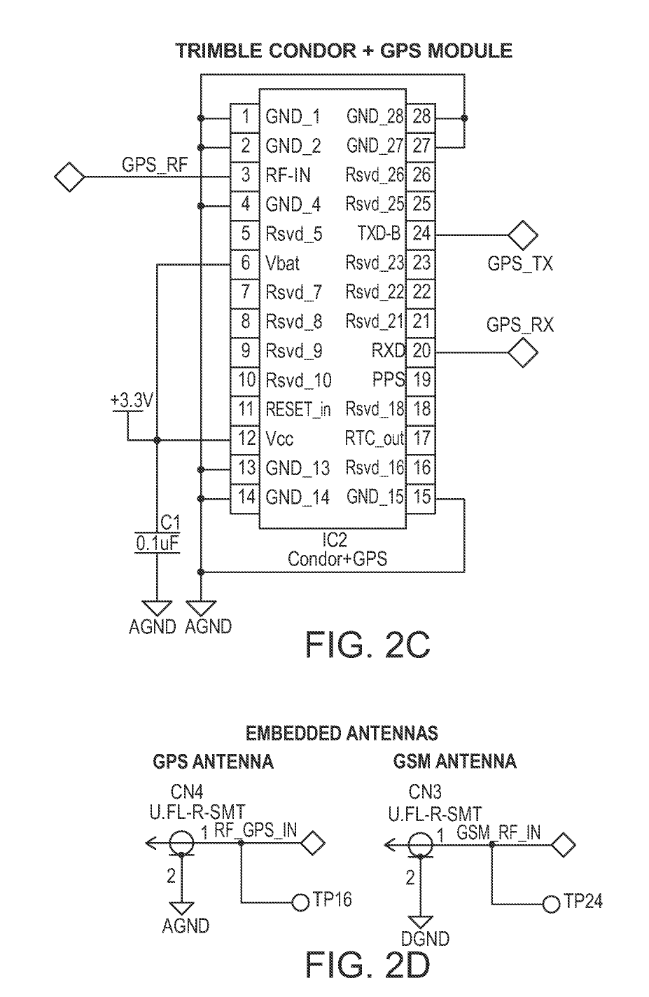

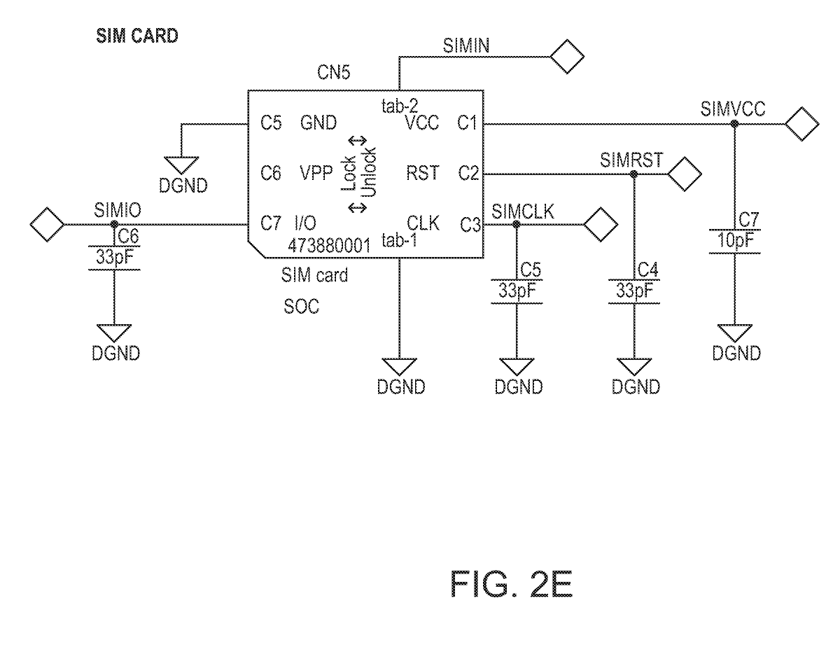

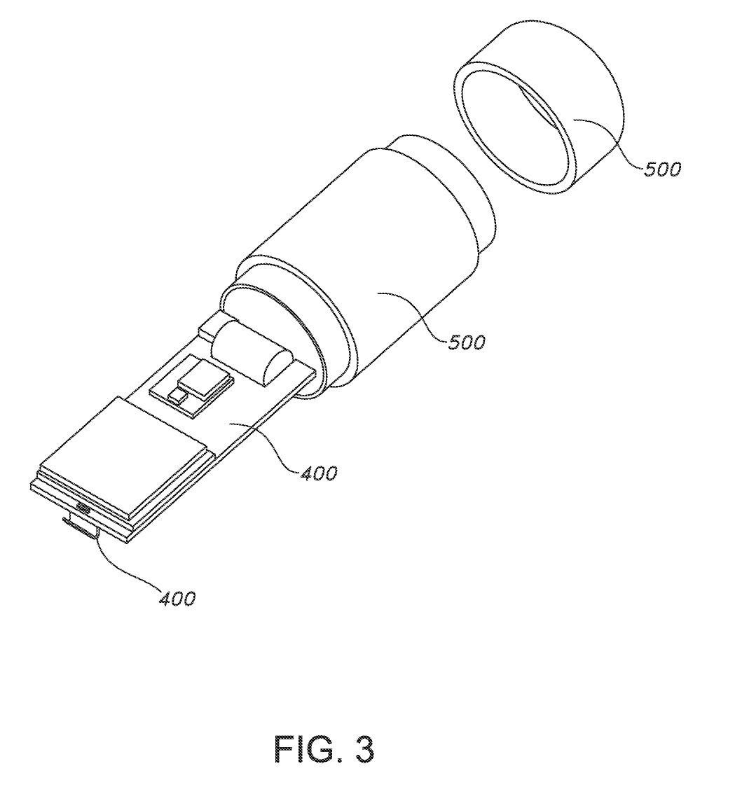

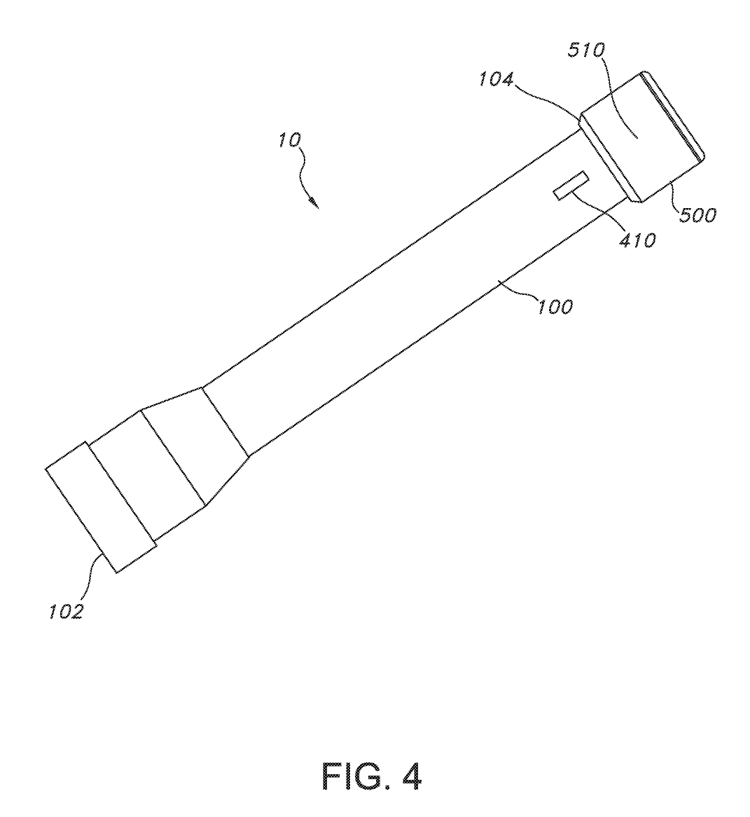

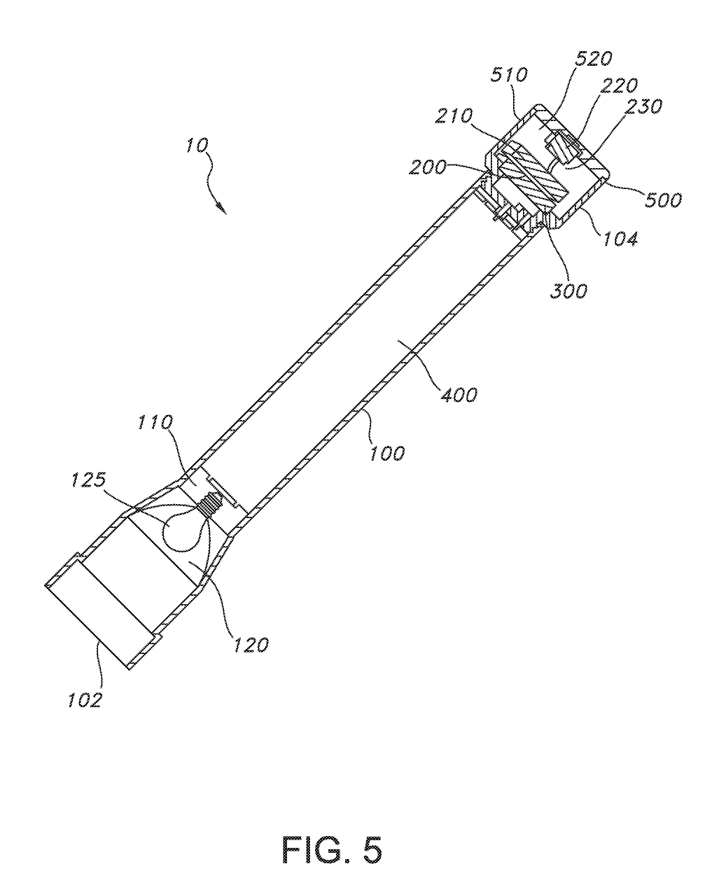

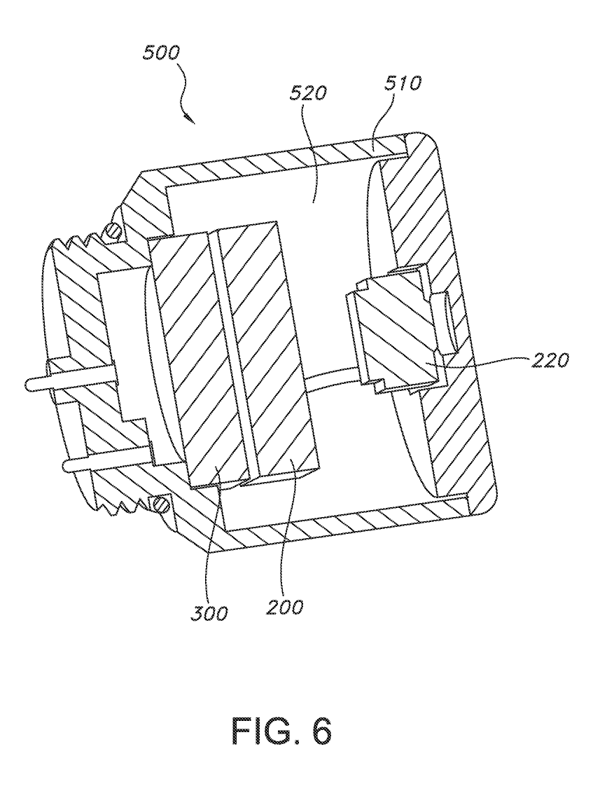

In one exemplified aspect, the location device may comprise a rechargeable power source 400. The power source 400 can be, for example, PCB power supply. In another aspect, the power source can comprise a lithium ion battery, or other rechargeable battery. The power source can comprise a port 410 to connect the power source 400 to an external power supply. In one aspect, the port 410 may comprise a standard USB port positioned on an external portion of the housing, either on the housing itself, or on the end cap 500, if desired. In one exemplified aspect, the power source can charge simultaneously with the power source of the device within which it resides, or separately if desired. For example, in the case of a flash light, as mentioned above, the location device can be formed to take the place of an ordinary screw-on end cap 500, selectively positioned thereon the proximal end 104 of the housing. As illustrated in FIG. 1, the location device can be located within the inner chamber 520 of the body of a selectively replaceable end cap. In this aspect, the location device 10 can be inserted into a standard flashlight in lieu of the end cap and the housing 100 can be configured to allow the batteries of the flashlight to be charged as per their normal use. In this aspect, the location module and communication element can be positioned within the inner chamber 520 of the body 510 of the end cap. As such, a separate battery may also be positioned therein the inner chamber. Similar location devices can be designed to fit within several other electronic devices, as one skilled in the art can appreciate. In one aspect, for example, the flashlight aspect, the housing comprises an aluminum tube matching the design of the flash light end (or other device, as necessary) with the board cold potted for durability and a laser fused high impact polycarbonate end to house the antenna.

In yet another aspect, the location device can be part of a tracking system. The tracking system, in one aspect, comprises one or more location devices and a computer aided dispatch system. The computer aided dispatch and device mapping system can be configured to receive the GPS data from the one or more location devices, store the location data, and display the data, including time, location, speed, and the like, on a computer screen or other capable device. It can also have the capability to transmit the location data externally, such as over the internet.

In another aspect, the location device 10 can be configured to comprise two or more modes of operation. For example, if the location device were used by a police officer, as described herein, modes for patrol and pursuit can be employed and can be triggered automatically or via a signal received from the Computer Aided Dispatch System. In this aspect, the location device can use the standard GPS tracking but also include triangulation to provide Advanced GPS (AGPS). In another aspect, the location module can also provide accelerometer data. The location device can wirelessly transmit to a server the location and status information based on frequency parameters of the “mode”.

Although several aspects of the invention have been disclosed in the foregoing specification, it is understood by those skilled in the art that many modifications and other aspects of the invention will come to mind to which the invention pertains, having the benefit of the teaching presented in the foregoing description and associated drawings. It is thus understood that the invention is not limited to the specific aspects disclosed hereinabove, and that many modifications and other aspects are intended to be included within the scope of the appended claims. Moreover, although specific terms are employed herein, as well as in the claims that follow, they are used only in a generic and descriptive sense, and not for the purposes of limiting the described invention.

What is claimed is:

1. A flashlight, comprising:
a housing having proximal and distal ends and defining an interior cavity;
a light assembly comprising a light source positioned at least partially within a portion of the interior cavity substantially adjacent the distal end;
a rechargeable power source positioned within the interior cavity;
a location module positioned at least partially within a portion of the interior cavity and configured to generate location data; and
a communication element positioned at least partially within a portion of the interior cavity and configured to transmit the location data from the location module to a remote receiver;
wherein the light assembly, location module, and communication element are electrically coupled to the rechargeable power source.

2. The flashlight of claim 1, wherein the location module comprises a GPS receiver and a GPS antenna.

3. The flashlight of claim 2, wherein the location module further comprises an RF antenna.

4. The flashlight of claim 1, wherein the communication element comprises a GSM modem.

5. The flashlight of claim 1, wherein the communication element comprises a CDMA modem.

6. The flashlight of claim 1, 5, or 4, wherein the communication element comprises an RF modem.

7. The flashlight of claim 6, wherein the RF modem utilizes WiFi technology.

8. The flashlight of claim 6, wherein the RF modem utilizes a 900 mHz band.

9. The flashlight of claim 1, further comprising a selectively replaceable end cap disposed thereon the proximal end of the housing configured to enclose the interior cavity.

10. The flashlight of claim 9, wherein the location module is positioned substantially within the selectively replaceable end cap.

11. The flashlight of claim 10, wherein the communication element is positioned substantially within the selectively replaceable end cap.

12. The flashlight of claim 1, wherein the power source comprises a rechargeable battery.

13. The flashlight of claim 12, wherein the rechargeable battery comprises a Lithium Ion battery.

14. The flashlight of claim 1, further comprising a USB port positioned on an external portion of the housing, wherein the USB port is electrically coupled to the power source.

15. The flashlight of claim 1, wherein the remote receiver is configured to receive the location data from the location module, store the location data, and transmit the stored location data over the internet.

16. The flashlight of claim 2, wherein the location module is configured to provide Advanced GPS data.

17. The flashlight of claim 2, wherein the location module is configured to provide accelerometer data.

18. An end cap for a flashlight having a housing, a light source positioned at a distal end of the housing, and a rechargeable power source positioned within an interior cavity of the housing, the end cap comprising:
a body defining an inner chamber;
a location module positioned at least partially within a portion of the inner chamber and configured to generate location data; and
a communication element positioned at least partially within a portion of the inner chamber and configured to transmit the location data from the location module to a remote receiver.

19. The end cap of claim 18, wherein the light source, location module, and communication element are all electrically coupled to the rechargeable power source.

20. The end cap of claim 18, further comprising a rechargeable battery positioned within a portion of the body for powering the location module and the communication element.

21. The end cap of claim 18, wherein the location module comprises a GPS receiver and a GPS antenna.

22. The end cap of claim 18, wherein the communication element comprises a GSM modem.

23. The end cap of claim 18, wherein the communication element comprises a CDMA modem.

24. The end cap of claim 18, 21, or 19, wherein the communication element comprises an RF modem.

25. The end cap of claim 24, wherein the RF modem utilizes WiFi technology.

26. The end cap of claim 24, wherein the RF modem utilizes a 900 mHz band.

27. The end cap of claim 20, wherein the rechargeable battery comprises a Lithium Ion battery.

28. The end cap of claim 20, further comprising a USB port positioned on an external portion of the body, wherein the USB port is electrically coupled to the rechargeable battery.

29. The end cap of claim 21, wherein the location module is configured to provide Advanced GPS data.

30. The end cap of claim 21, wherein the location module is configured to provide accelerometer data.
